(19) United States
(12) Patent Application Publication
(10) Pub. No.: US 2023/0169749 A1
(43) Pub. Date: Jun. 1, 2023

(54) SKIN COLOR DETECTION METHOD AND APPARATUS, TERMINAL, AND STORAGE MEDIUM

(71) Applicants: HUAWEI TECHNOLOGIES CO., LTD., Shenzhen (CN); Institute of Automation, Chinese Academy of Sciences, Beijing (CN)

(72) Inventors: Yidan Zhou, Beijing (CN); Yuewan Lu, Shenzhen (CN); Xiaotang Chen, Beijing (CN); Kaiqi Huang, Beijing (CN); Chen Dong, Shenzhen (CN); Wenmei Gao, Shenzhen (CN)

(21) Appl. No.: 17/921,304

(22) PCT Filed: Apr. 20, 2021
(86) PCT No.: PCT/CN2021/088275

§ 371 Date: Oct. 25, 2022

(30) Foreign Application Priority Data
Apr. 27, 2020 (CN) 202010345814.4

(51) Int. Cl. G06V 10/56; G06V 10/25; G06V 10/60; G06V 10/44; G06V 40/16

(52) U.S. Cl. CPC G06V 10/56; G06V 10/25; G06V 10/60; G06V 10/449; G06V 40/171

(57) ABSTRACT

This application provides a skin color detection method and apparatus. The skin color detection method includes: obtaining a face image (101); determining a face key point (102) in the face image; determining a skin color estimation region of interest (Region Of Interest, ROI) and an illumination estimation region of interest ROI (103) in the face image based on the face key point; obtaining a detected skin color value (104) corresponding to the skin color estimation region of interest; obtaining a detected illumination color value (105) corresponding to the illumination estimation region of interest; and using the detected skin color value and the detected illumination color value as feature input of a skin color estimation model, and obtaining a corrected skin color value (106) output by the skin color estimation model.

This application claims priority to Chinese Patent Application No. 202010345814.4, filed with the China National Intellectual Property Administration on Apr. 27, 2020 and entitled “SKIN COLOR DETECTION METHOD AND APPARATUS, TERMINAL, AND STORAGE MEDIUM”, which is incorporated herein by reference in its entirety.

### TECHNICAL FIELD

This application relates to the field of image processing technologies, and in particular, to a skin color detection method and apparatus, a terminal, and a storage medium.

### BACKGROUND

With intelligent development of a terminal such as a mobile phone, the terminal can implement increasingly more functions. For example, skin health detection may be implemented by using a mobile phone, to further implement skin care. Currently, a skin detection manner implemented by using a mobile phone is based on processing of a shot image of a skin, to determine a skin color. However, there is a relatively large difference between a skin color detected by a terminal and a real skin color. Consequently, a detection result is inaccurate.

### SUMMARY

Embodiments of this application provide a skin color detection method and apparatus, a terminal, and a storage medium, to improve accuracy of skin color detection.

According to a first aspect, an embodiment of this application provides a skin color detection method, including: obtaining a face image; determining a face key point in the face image; determining a skin color estimation region of interest and an illumination estimation region of interest in the face image based on the face key point; obtaining a detected skin color value corresponding to the skin color estimation region of interest; obtaining a detected illumination color value corresponding to the illumination estimation region of interest; and using the detected skin color value and the detected illumination color value as feature input of a skin color estimation model, and obtaining a corrected skin color value output by the skin color estimation model.

Optionally, the obtaining a detected skin color value corresponding to the skin color estimation region of interest includes: obtaining, through screening by using an elliptic skin color model, a pixel that is in the skin color estimation region of interest and that meets a preset condition; and calculating an average value of detected skin color values of the skin color estimation region of interest based on the pixel that is in the skin color estimation region of interest and that meets the preset condition, and using the average value as the detected skin color value corresponding to the skin color estimation region of interest.

Optionally, the obtaining a detected illumination color value corresponding to the illumination estimation region of interest is: obtaining the detected illumination color value corresponding to the illumination estimation region of interest by using Gaussian filtering and a shades of gray algorithm.

Optionally, the corrected skin color value output by the skin color estimation model includes an RGB color value or an LAB color value.

Optionally, the obtaining a corrected skin color value output by the skin color estimation model includes: obtaining an RGB color value output by the skin color estimation model. The skin color detection method further includes: converting the RGB color value output by the skin color estimation model into an HSV color value, and determining a skin color tone based on the HSV color value; and converting the RGB color value output by the skin color estimation model into an LAB color value, obtaining a corresponding individual typology angle ITA based on the LAB color value, and determining a skin color code based on the ITA.

Optionally, the obtaining a corrected skin color value output by the skin color estimation model includes: obtaining an RGB color value and an individual typology angle ITA that are output by the skin color estimation model. The skin color detection method further includes: converting the RGB color value output by the skin color estimation model into an HSV color value, and determining a skin color tone based on the HSV color value; and determining a skin color code based on the ITA output by the skin color estimation model.

Optionally, the skin color detection method further includes: generating a skin detection result interface, where the skin detection result interface includes a skin color bar, and the skin color bar includes the skin color code; and generating a skin color details interface in response to a selection instruction of the skin color bar, where the skin color details interface includes the skin color code, the skin color tone, and a skin care suggestion.

Optionally, before the obtaining a face image, the skin color detection method further includes: generating a skin detection interface, where the skin detection interface includes skin detection history information and a skin detection icon; and in response to a selection instruction of the skin detection icon, entering a process of obtaining the face image.

According to a second aspect, an embodiment of this application provides a skin color detection apparatus, including: an image obtaining module, configured to obtain a face image; a key point determining module, configured to determine a face key point in the face image; a region determining module, configured to determine a skin color estimation region of interest and an illumination estimation region of interest in the face image based on the face key point; a skin color detection module, configured to obtain a detected skin color value corresponding to the skin color estimation region of interest; an illumination detection module, configured to obtain a detected illumination color value corresponding to the illumination estimation region of interest; and a skin color correction module, configured to use the detected skin color value and the detected illumination color value as feature input of a skin color estimation model, and obtain a corrected skin color value output by the skin color estimation model.

According to a third aspect, an embodiment of this application provides a skin color detection apparatus, including a processor and a memory. The memory is configured to store at least one instruction, and when the instruction is loaded and executed by the processor, the foregoing skin color detection method is implemented.

According to a fourth aspect, an embodiment of this application provides a terminal, including the foregoing skin color detection apparatus.

According to a fifth aspect, an embodiment of this application provides a computer-readable storage medium. The computer-readable storage medium stores a computer program, and when the computer program is run on a computer, the computer is enabled to perform the foregoing skin color detection method.

According to the skin color detection method and apparatus, the terminal, and the storage medium in the embodiments of this application, the skin color estimation region of interest and the illumination estimation region of interest are determined based on the face key point, and detection is separately performed on the two regions to obtain the detected skin color value and the detected illumination color value. The two color values are used as the feature input of the skin color estimation model, to obtain the corrected skin color value output by the skin color estimation model. The skin color estimation model may be established in advance based on training data of different ambient light sources and different terminals. Therefore, the corrected skin color value output by the skin color estimation model is closer to a real skin color, impact on the skin color caused by different characteristics of camera photosensitive elements in the terminals and different ambient illumination is reduced, and accuracy of skin color detection is improved.

### BRIEF DESCRIPTION OF DRAWINGS

FIG. 1 is a flowchart of a skin color detection method according to an embodiment of this application;

FIG. 2 is a schematic diagram of a face key point according to an embodiment of this application;

FIG. 3 is a schematic diagram of a skin color estimation region of interest according to an embodiment of this application;

FIG. 4 is a schematic diagram of an illumination estimation region of interest according to an embodiment of this application;

FIG. 5 is a schematic diagram of elliptic distribution met by a skin color according to an embodiment of this application;

FIG. 6 is a schematic diagram of a status of a skin detection result interface according to an embodiment of this application;

FIG. 7 is a schematic diagram of a status of a skin color details interface according to an embodiment of this application;

FIG. 8 is a schematic diagram of a status of a skin detection interface according to an embodiment of this application; and

FIG. 9 is a schematic diagram of population distribution corresponding to different ITA threshold intervals according to an embodiment of this application.

### DESCRIPTION OF EMBODIMENTS

Terms used in embodiments of this application are only used to explain specific embodiments of this application, but are not intended to limit this application.

Before the embodiments of this application are described, a problem of a conventional technology is briefly described first. For a terminal such as a mobile phone, different models of cameras have different imaging qualities, and each photosensitive element of the mobile phone responds differently to illumination at different frequencies. When an external illumination environment changes, different white balance algorithms are triggered. As a result, photos shot by different mobile phones and in environments with different light intensity and color temperatures usually have a relatively large color cast. Consequently, accuracy of a skin color detection method in a current terminal is relatively poor. The following describes the embodiments of this application.

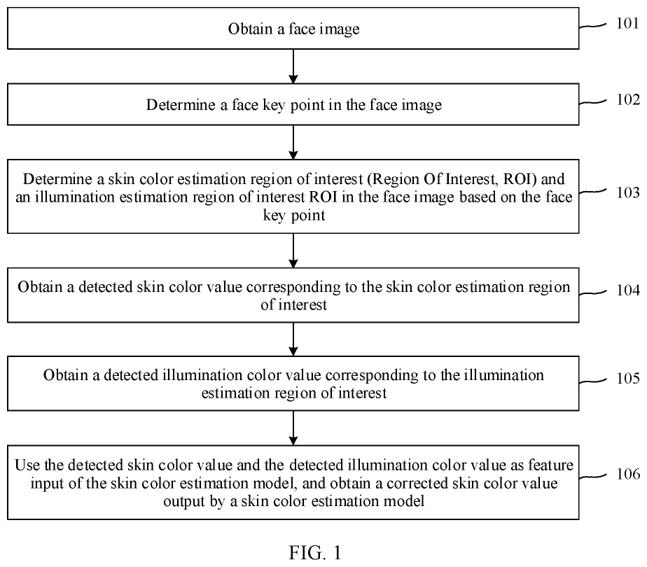

As shown in FIG. 1, FIG. 1 is a flowchart of a skin color detection method according to an embodiment of this application. An embodiment of this application provides a skin color detection method, including the following steps.

Step 101: Obtain a face image.

Step 102: Determine a face key point in the face image.

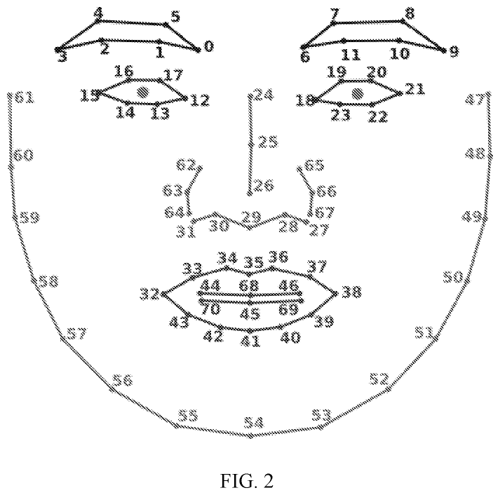

Specifically, as shown in FIG. 2, FIG. 2 is a schematic diagram of a face key point according to an embodiment of this application. FIG. 2 accurately feeds back locations of key points of facial features and contours in the image, and each number represents a key point. FIG. 2 shows 71 key points of a face. It should be noted that a quantity and locations of the key points in FIG. 2 are merely examples. A specific quantity and locations of the key points are related to a face detection library. The quantity and the locations of the key points of the face are not limited in this embodiment of this application.

Step 103: Determine a skin color estimation region of interest (Region Of Interest, ROI) and an illumination estimation region of interest ROI in the face image based on the face key point.

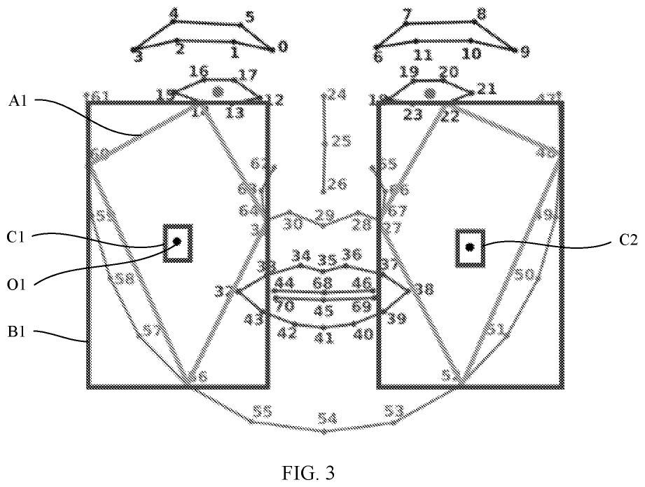

For selection of the skin color estimation ROI, after the face key points are determined, spatial location information of the face and five sense organs may be more accurately obtained. To more accurately determine a real skin color of a person in the image, an appropriate region needs to be selected for analysis. This is because not all regions of the face are skins, and eyes, eyebrows, lips, and the like are not in a skin color analysis range. Due to an angle, a large area of shade appears in a visible region at the back of cheeks, and interferes with subsequent skin color analysis. Therefore, in this embodiment of this application, a flat region under the eyes is selected as the ROI for subsequent skin color estimation, to avoid a shade region, a reflection region, and a region that does not fall within the skin color analysis range. Because the face is left-right symmetrical, two symmetrical regions on left and right sides are selected during ROI selection. The following uses a left region (from a perspective of an observer) as an example to explain how to select an ROI region. As shown in FIG. 3, FIG. 3 is a schematic diagram of a skin color estimation region of interest according to an embodiment of this application. In the image in which the face key points are determined, a quadrilateral region A1 may be framed by using key points 14, 31, 56, and 60 as vertexes. The quadrilateral region A1 is used as an inscribed quadrilateral, so that a bounding rectangle B1 of the quadrilateral region A1 and a central point O1 of the bounding rectangle B1 may be further obtained. Then, the bounding rectangle B1 is proportionally reduced by using the central point O1 as a center, to form a small rectangle C1 having the same center as the bounding rectangle B1, and the small rectangle C1 is used as one skin color estimation ROI. A rectangle C2 in a right region may be determined based on a same principle, and the rectangle C2 may be used as the other skin color estimation ROI. That is, C1 and C2 in FIG. 3 are skin color estimation ROIs.

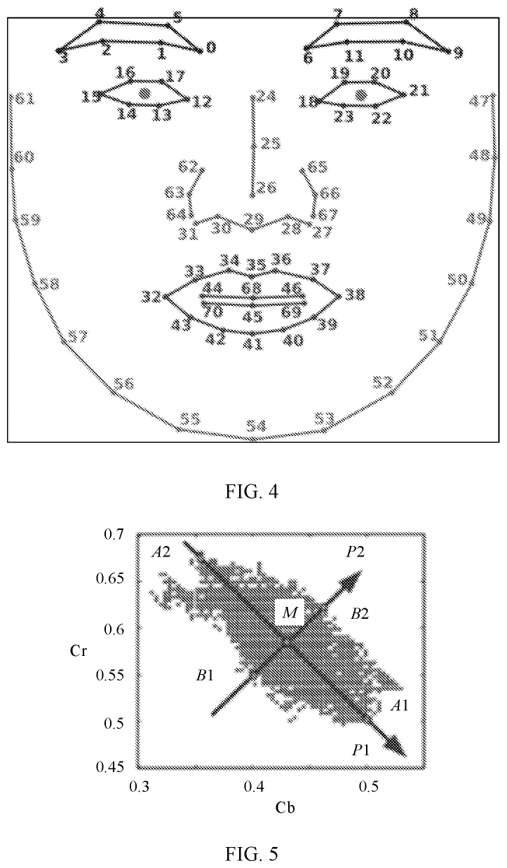

For selection of the illumination estimation ROI, first, the face image includes a background region in addition to a face region. A skin color estimation model is used in a subsequent step, and the skin color estimation model is obtained in advance through training based on training data. A collection scenario of the training data is a photo studio, and a background is relatively simple. If the model is trained on a basis of global illumination estimation, the model is easily interfered by a background when being applied to an actual scenario. Therefore, illumination estimation is only considered in the face region. An approximate rectangular face region may be first determined by using a face detection algorithm, and the region may be used as an illumination estimation ROI. For example, in this embodiment of this application, as shown in FIG. 4, FIG. 4 is a schematic diagram of an illumination estimation region of interest according to an embodiment of this application. For example, a rectangular box is selected by using a horizontal height of key points 4 and 8 as an upper height limit, using a height of a key point 54 as a lower limit, and using a width between 61 and 47 as a left-right width, and a region of the rectangular box is used as an illumination estimation ROI.

Step 104: Obtain a detected skin color value corresponding to the skin color estimation region of interest.

Step 105: Obtain a detected illumination color value corresponding to the illumination estimation region of interest.

It should be noted that an execution sequence between step 104 and step 105 is not limited in this embodiment of this application.

Step 106: Use the detected skin color value and the detected illumination color value as feature input of the skin color estimation model, and obtain a corrected skin color value output by the skin color estimation model.

Specifically, the skin color estimation model is a regression model, which may be obtained in advance through training based on training data. For example, a face image is collected in advance, and a real color value of a skin color of a person is detected by using a skin color detector, for example, color values of a total of 12 points on left and right cheeks of a photographed person are detected. The color value may include an RGB color value and an LAB color value. An individual typology angle (Individual Typology Angle, ITA) may be further detected. The RGB color value includes R, G, and B, where R represents a red color value, G represents a green color value, and B represents a blue color value. The LAB color value represents coordinates in an LAB color space. L represents black-and-white lightness, which is mainly affected by melanin in skin color measurement. A value of a represents red-green chromaticity, where a positive value represents red, a negative value represents green, and the red-green chromaticity is mainly affected by an oxygenation degree of oxygenated hemoglobin in skin color measurement. A value of b represents yellow-blue chromaticity in a horizontal axis, where a positive value represents yellow, a negative value represents blue, and the yellow-blue chromaticity can reflect a yellow degree of a skin. The ITA can reflect a degree of pigmentation in the skin. A higher ITA indicates a lighter skin color, and a lower ITA indicates a darker skin color. An average value of the detected color values corresponding to the 12 points may be used as the real value of the skin color. For example, as shown in Table 1, a plurality of mobile phones are used for each person to shoot a face image in 18 light source environments shown in Table 1, a camera is 20 to 40 cm away from a face, and a flash is turned on.

TABLE 1

| Light Source | Illumination Combination | Color | Illuminance |
|---|---|---|---|
| Type | (5500 k-3200 k) | Temperature (k) | (lux) |
| 1 | 33%-00% | 5630 | 300 |
| 2 | 01%-01% | 4100 | 100 |
| 3 | 00%-07% | 3100 | 100 |
| 4 | 00%-30% | 3200 | 300 |
| 5 | 00%-60% | 3200 | 550 |
| 6 | 00%-90% | 3200 | 765 |
| 7 | 30%-00% | 5700 | 315 |
| 8 | 30%-30% | 4130 | 620 |
| 9 | 30%-60% | 3800 | 845 |
| 10 | 30%-90% | 3650 | 1120 |
| 11 | 60%-00% | 5680 | 570 |
| 12 | 60%-30% | 4530 | 870 |
| 13 | 60%-60% | 4130 | 1130 |
| 14 | 60%-90% | 3935 | 1340 |
| 15 | 90%-00% | 5640 | 805 |
| 16 | 90%-30% | 4755 | 1100 |
| 17 | 90%-60% | 4357 | 1370 |
| 18 | 90%-90% | 4160 | 1570 |

Table 1 shows 18 light source environments, and each light source environment has a corresponding illumination color value. For example, a mobile phone T1 is used to shoot a face image of a tester P1 under a light source type 1, to obtain a face image K1. A real color value X1 of a skin color is obtained by using the skin color detector to measure the tester P1. The mobile phone T1 is used to perform skin color detection on the face image K1, to obtain a detected skin color value Y1. A skin color detection process herein may be the same as the manner in step 104. The mobile phone T1 is used to perform illumination detection on the face image K1, to obtain a detected illumination color value Z1. An illumination detection process herein may be the same as the manner in step 105. A first set of training data is obtained, including X1, Y1, and Z1. The mobile phone T1 is used to shoot a face image of the tester P1 under a light source type 2, to obtain a face image K2. The real color value of the skin color of the tester P1 is X1. The mobile phone T1 is used to perform skin color detection on the face image K2, to obtain a detected skin color value Y2. The mobile phone T1 is used to perform illumination detection on the face image K2, to obtain a detected illumination color value Z2. A second set of training data is obtained, including X1, Y2, and Z2. By analogy, a plurality of sets of training data are obtained by using different mobile phones and in different light source environments, and the obtained plurality of sets of training data are used to perform training, to establish a skin color estimation model. A training process is performed in advance. In the skin color detection method in this embodiment of this application, in step 106, the detected skin color value and the detected illumination color value that are currently detected are used as the feature input of the skin color estimation model. Because the skin color estimation model is established based on training data of different light source environments and different terminals during shooting, the corrected skin color value obtained based on the skin color estimation model is closer to the real skin color.

According to the skin color detection method in this embodiment of this application, the skin color estimation region of interest and the illumination estimation region of interest are determined based on the face key point, and detection is separately performed on the two regions to obtain the detected skin color value and the detected illumination color value. The two color values are used as the feature input of the skin color estimation model, to obtain the corrected skin color value output by the skin color estimation model. The skin color estimation model may be established in advance based on training data of different ambient light sources and different terminals. Therefore, the corrected skin color value output by the skin color estimation model is closer to the real skin color, impact on the skin color caused by different characteristics of camera photosensitive elements in the terminals and different ambient illumination is reduced, and accuracy of skin color detection is improved.

Optionally, step 104 of obtaining a detected skin color value corresponding to the skin color estimation region of interest includes: obtaining, through screening by using an elliptic skin color model, a pixel that is in the skin color estimation region of interest and that meets a preset condition; and calculating an average value of detected skin color values of the skin color estimation region of interest based on the pixel that is in the skin color estimation region of interest and that meets the preset condition, and using the average value as the detected skin color value corresponding to the skin color estimation region of interest.

Specifically, a skin condition of each person varies from person to person, some people have a smooth face, but some people have many pimples, spots, moles, or other non-skin color regions, and these regions are prone to interfere with skin color estimation to different degrees. Therefore, in step 104, these non-skin color pixels need to be excluded, only pure skin pixels are retained, and skin color detection is performed based on the pure skin pixels. A skin color is mainly determined by blood and melanin. The blood causes a skin to be yellow and red in tone, and the melanin causes the skin to be chocolate-brown in tone. Saturation of the skin is limited. Illumination changes in a daily living environment are limited. Under the limited change condition, skin colors can converge in a specific limited region in a color space. The elliptic skin color model uses a YCrCb color space. It is assumed that a color of a pixel is (R, G, B). After being converted into the YCrCb color space, the color is as follows:

$$\{ \begin{matrix}Y = 0.299 R + 0.587 G + 0.114 B \\ Cb = - 0.1687 R - 0.3313 G + 0.5 B + 128 \\ Cr = 0.5 R - 0.4187 G - 0.0813 B + 128\end{matrix}$$

Because the skin color is greatly affected by a value of Y, Y needs to be adjusted. That is, piecewise nonlinear transformation is performed on each YCbCr color value. After the transformation, the color value is expressed as follows:

$$Ctr ( Y ) = \{ \begin{matrix}( Cr ( Y ) - Dr ( Y ) ) \frac{Wr}{wr ( y )} + Dr ( Kh ) ; if : y < Kl or kh < y \\ Cr ( Y ) ; if : y ∈ [ Kl , Kh ]\end{matrix} \\ Wr ( Y ) = \{ \begin{matrix}WLcr + \frac{( Y - Ymi ) ( Wcr - WLcr )}{Kl - Ymi} ; if : ym < KL \\ WHcr + \frac{( Yma - Y ) ( Wcr - WLcr )}{Yma - Kh} ; if : kh < y\end{matrix}$$

Herein, Wcb=46.95, WLcb=23, WHcb=14, Wcr=38.76, WLcr=20, WHci=10, Kl=25, Kh=188, Ymi=16, and Yma=235. Finally, the distribution may be expressed by using an elliptic equation:

$$\frac{{( X - ecx )}^{2}}{{a}^{2}} + \frac{{( Y - ecy )}^{2}}{{b}^{2}} = 1 \\ [ \begin{matrix}X \\ Y\end{matrix} ] = ( \begin{matrix}cos θ & sin θ \\ - sin θ & cos {θ}^{′}\end{matrix} ) [ \begin{matrix}Ctb - cx \\ Ctr - cy\end{matrix} ]$$

Herein, cx=109.38, cy=152.02, 0=2.53, ecx=2.41, a=25.39, and b=14.03.

As shown in FIG. 5, FIG. 5 is a schematic diagram of elliptic distribution met by a skin color according to an embodiment of this application. Black sample points in the figure are a large quantity of skin color values collected from samples. In step 104, a detected skin color value of each pixel in the skin color estimation region of interest is obtained, the detected skin color value of the pixel is converted into two coordinates Cr and Cb, and then a point corresponding to the coordinates is found in a coordinate system shown in FIG. 5. If the point corresponding to the coordinates is located in an ellipse, it is determined that the pixel meets the preset condition and belongs to a skin. If the point corresponding to the coordinates is located outside the ellipse, it is determined that the pixel does not meet the preset condition, and belongs to a non-skin such as a pimple, a spot, or a mole. After detection and determining on all pixels in the skin color estimation region of interest are completed, that is, screening is completed, an average value of all detected skin color values meeting the preset condition is calculated, and the average value is used as the detected skin color value corresponding to the skin color estimation region of interest.

Optionally, step 105 of obtaining a detected illumination color value corresponding to the illumination estimation region of interest is: obtaining the detected illumination color value corresponding to the illumination estimation region of interest by using Gaussian filtering and a shades of gray shades of gray algorithm.

Specifically, besides a characteristic of a camera photosensitive element of a terminal, an illumination condition is another important factor that affects an image color. Under a standard light source, imaging of an object is considered to be closest to a real color. When a color temperature or intensity of illumination on a surface of the object changes, an imaging color of the object also changes. Objects that have different colors and that are matched with different illumination may even present a same color. The shades of gray algorithm is an unsupervised algorithm in which a color of a scene light source is detected based on an image feature. An advantage of the algorithm is that no training needs to be performed in advance. The shades of gray algorithm is obtained by using a Minkowski normal form to improve a gray world gray world algorithm; and is based on an assumption that an image pixel still has no chromatic aberration after nonlinear reversible transformation, and an average color of an image is an illumination color of the image. A formal description is as follows:

$$\frac{\int {[ f ( x ) ]}^{p} dx}{\int dx} = k$$

Herein, x represents a pixel value, and p represents the Minkowski normal form. Therefore, illumination chromaticity may be calculated:

$${[ \frac{\int {[ f ( x ) ]}^{p} dx}{\int dx} ]}^{1 / p} = ke$$

Further, it is proved that Gaussian pre-filtering performed on an image may further improve an illumination estimation effect. Therefore, a final illumination estimation form is as follows, where G^{σ} represents a Gaussian filter.

$${[ \frac{\int {[ f ( x , λ ) ⊗ {G}^{σ} ]}^{p} dx}{\int dx} ]}^{1 / p} = ke$$

An illumination estimation result obtained by using the foregoing algorithm is the detected illumination color value corresponding to the illumination estimation region of interest.

Optionally, in step 106, the corrected skin color value output by the skin color estimation model includes an RGB color value or an LAB color value.

Specifically, for example, the detected skin color value obtained in step 104 is an RGB color value (R₁, G₁, B₁), the detected illumination color value obtained in step 105 is an RGB color value (R₂, G₂, B₂), and the corrected skin color value output by the skin color estimation model is an RGB color value (R₃, G₃, B₃). The skin color estimation model may be a support vector regression (support vector regression, SVR) model, and the SVR may be considered as a regression version of a support vector machine (support vector machine, SVM). The SVM is mainly used for a classification problem. The SVM maps an input feature to a high-dimensional space depending on a kernel function, and finds a maximized support vector interval, to determine a hyperplane to separate features of different samples. The SVM aims to maximize a distance from a nearest sample point to the hyperplane, and the SVR aims to minimize a distance from a farthest sample point to the hyperplane. The skin color estimation model may include three models SVR₁, SVR₂, and SVR₃, which are respectively used to implement mapping relationships between color values of three channels.

R₃=SVR₁(R₁,G₁,B₁,R₂,G₂,B₂)

G₃=SVR₂(R₁,G₁,B₁,R₂,G₂,B₂)

B₃=SVR₃(R₁,G₁,B₁,R₂,G₂,B₂)

In another feasible implementation, input and output of the skin color estimation model may be LAB color values, that is, LAB coordinates are used as the input and the output of the model. In addition, in another feasible implementation, the skin color estimation model may alternatively be another type of model.

Optionally, in step 106, the obtaining a corrected skin color value output by the skin color estimation model includes: obtaining an RGB color value output by the skin color estimation model. The skin color detection method further includes:

converting the RGB color value output by the skin color estimation model into an HSV color value, and determining a skin color tone based on the HSV color value; and

converting the RGB color value output by the skin color estimation model into an LAB color value, obtaining a corresponding individual typology angle (Individual Typology Angle, ITA) based on the LAB color value, and determining a skin color code based on the ITA.

Specifically, the HSV color value is a coordinate value in a hue, saturation, and value (Hue, Saturation, Value) color space, and the skin color tone needs to be determined based on the HSV color value. Therefore, the RGB color value needs to be first converted into the HSV color value. The ITA can reflect a degree of pigmentation in the skin. A higher ITA indicates a lighter skin color, and a lower ITA indicates a darker skin color. The skin color is determined by the ITA, and the ITA needs to be calculated by using the LAB color value. Therefore, the RGB color value needs to be first converted into the LAB color value, then the ITA is calculated based on the LAB color value, and finally, the skin color code is determined based on the ITA. The skin color tone and the skin color code together may be used as a basis for skin care. A process of calculating the ITA based on the LAB color value may be specifically

$$ITA = arc tan ( \frac{L - 50}{b} ) \times \frac{180}{π} ,$$

where L represents black-and-white lightness in the LAB color space, and b represents yellow-blue chromaticity in the LAB color space.

Optionally, in step 106, the obtaining a corrected skin color value output by the skin color estimation model includes: obtaining an RGB color value and an individual typology angle ITA that are output by the skin color estimation model. The skin color detection method further includes:

converting the RGB color value output by the skin color estimation model into an HSV color value, and determining a skin color tone based on the HSV color value; and

determining a skin color code based on the ITA output by the skin color estimation model.

Specifically, the skin color estimation model may further include a fourth model SVR₄, and ITA=SVR₄(R₁, G₁, B₁, R₂, G₂, B₂). The SVR₄ is used to indicate a mapping relationship between an ITA and a color value. That is, in this embodiment, the ITA does not need to be calculated by converting the RGB color value, but the ITA is directly output by the skin color estimation model. The skin color code is determined by using the ITA. For the skin color tone, the RGB color value may be first converted into the HSV color value in a similar manner, and then the skin color tone is determined based on the HSV color value.

For the determining of the skin color tone, in the technical solution in this embodiment of this application, a cold, neutral, and warm tone division method of Pantone skin colors is used as a standard, statistics on a distribution law of cold, neutral, and warm Pantone skin colors in an H channel are collected, and a tone threshold is set. A detected skin color is converted to the HSV space, and a tone level is divided based on an H value. For example, if H>12, the tone is determined to be warm; if 12≥H>10, the tone is determined to be neutral; and if H≤10, the tone is determined to be cold.

In addition, it should be noted that, in this embodiment of this application, only the RGB color value is used as an example for description. In this embodiment of this application, a color value representation form of a skin color or illumination is not limited, and may be an RGB color value, or may be a color value represented by coordinates in another color space.

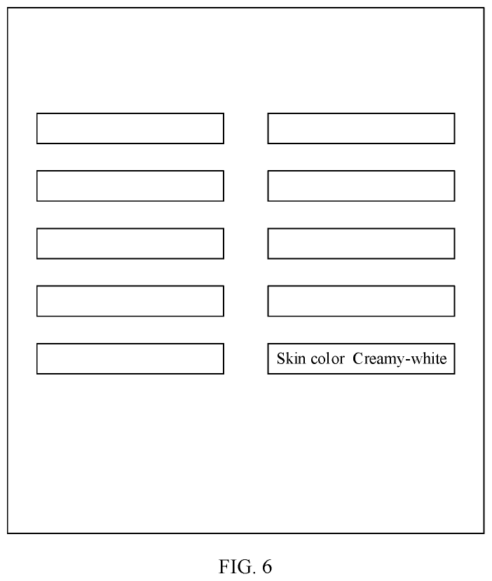

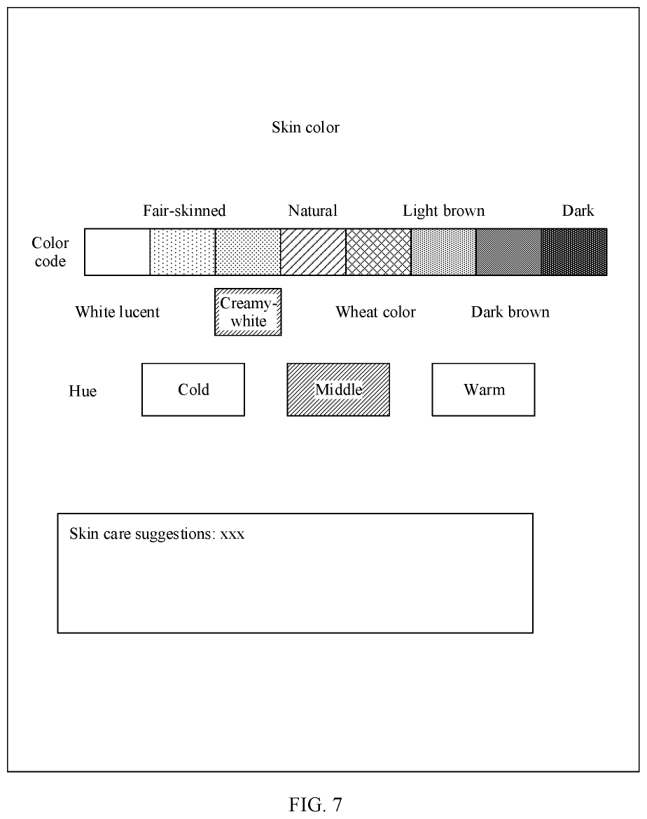

Optionally, as shown in FIG. 6 and FIG. 7, FIG. 6 is a schematic diagram of a status of a skin detection result interface according to an embodiment of this application, and FIG. 7 is a schematic diagram of a status of a skin color details interface according to an embodiment of this application. The skin color detection method further includes: generating a skin detection result interface, where as shown in FIG. 6, the skin detection result interface includes a skin color bar, and the skin color bar includes the skin color code, for example, the color code is creamy-white; and generating a skin color details interface in response to a selection instruction of the skin color bar, where as shown in FIG. 7, the skin color details interface includes the skin color code, the skin color tone, and a skin care suggestion.

Specifically, for example, on the skin detection result interface shown in FIG. 6, a plurality of status bars are included, where the skin color bar is used to display a skin color detection result, for example, creamy-white. For example, a pore status bar may be further included, to display a pore detection score; and for example, a blackhead status bar may be further included, to display a blackhead detection score. That is, the skin detection result interface may be used to display detection results for various skin items. Each single bar may be clicked to enter a details interface. For example, the skin color details interface shown in FIG. 7 is generated and entered in response to the selection instruction of the skin color bar. The skin color details interface includes a skin color code bar, which is used to specifically display the skin color code. The skin color code may be more intuitively displayed in a visual form. For example, the skin color code is displayed in a color card form, where a color code “creamy-white” corresponding to a detection result is highlighted. The skin detection result interface further includes a skin color tone bar, which is used to display the skin color tone. The skin color code and the skin color tone herein are detection results determined based on a result output by the skin color estimation model. In addition, the skin color details interface may further include a skin care suggestion. The skin care suggestion may be content determined based on a corresponding skin color code and skin color tone, and is used to provide a targeted skin care suggestion based on a detection result.

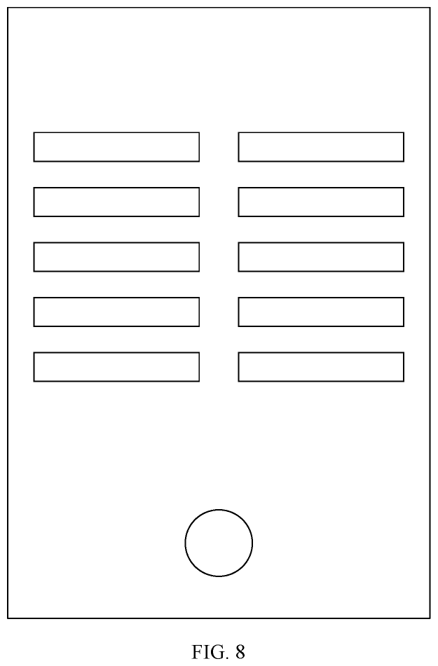

Optionally, as shown in FIG. 8, FIG. 8 is a schematic diagram of a status of a skin detection interface according to an embodiment of this application. Before step 101 of obtaining a face image, the skin color detection method further includes: generating a skin detection interface, where the skin detection interface includes skin detection history information and a skin detection icon; and in response to a selection instruction of the skin detection icon, entering a process of obtaining the face image.

Specifically, for example, rectangular boxes in FIG. 8 represent history information of various skin detection items, for example, including a pore detection score, a blackhead detection score, and a skin color detection result of previous detection, so that a user knows historical detection information before performing skin detection. A circular box in FIG. 8 represents a skin detection icon. When the user clicks the icon, a selection instruction of the skin detection icon is generated, and in response to the selection instruction of the skin detection icon, a process of obtaining a face image is entered, that is, step 101 is entered. For example, after the skin detection icon is clicked, an image selection interface may be first entered, and includes a shooting option and a memory reading option. If the shooting option is selected, a shooting interface is entered, and the user may control the terminal to shoot an image. After the shooting is completed, step 101 is entered, and the currently shot image is used as an obtained face image in step 101. If the memory reading option is selected, a reading selection interface is entered, and the user may select a picture from a memory of the terminal. After the selection is completed, step 101 is entered, and the currently selected picture is used as an obtained face image in step 101.

The following provides a comparison between a result detected in this embodiment of this application and a real value detected by a dedicated detector, to further describe an effect of this embodiment of this application, as shown in Table 2.

TABLE 2

| Terminal | Average Error | Average |
|---|---|---|
| Model | (RGB Color Value) | Error (ITA) |
| 1 | 19.86 | 6.89 |
| 2 | 20.03 | 6.56 |
| 3 | 22.45 | 7.03 |
| Average value | 20.78 | 6.83 |

Table 2 shows average errors at a plurality of terminals, including average errors between RGB color values detected in this embodiment of this application and real RGB color values detected by a dedicated measuring instrument at three terminals, and average errors between ITAs detected in this embodiment of this application and real ITAs detected by the dedicated measuring instrument at the three terminals. It may be learned from the table that an error between a result detected in this embodiment of this application and a real result is relatively small.

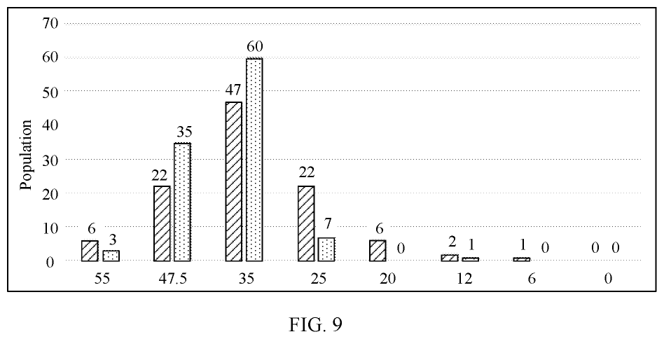

As shown in FIG. 9, FIG. 9 is a schematic diagram of population distribution corresponding to different ITA threshold intervals according to an embodiment of this application. A horizontal coordinate represents an ITA threshold interval. For example, ITAs are divided into eight threshold intervals based on skin color characteristics of Asians, and the eight threshold intervals may correspond to eight levels of skin color codes. A vertical coordinate represents a population. Diagonal filling indicates population distribution results that are of different color code levels and that are detected by a dedicated measuring instrument. Dot filling indicates population distribution results that are of different color code levels and that are detected in this embodiment of this application. It may be learned that population distribution corresponding to the diagonal filling and the dot filling is relatively close, that is, a difference between a result detected in this embodiment of this application and a real result is relatively small.

An embodiment of this application further provides a skin color detection apparatus, including: an image obtaining module, configured to obtain a face image; a key point determining module, configured to determine a face key point in the face image; a region determining module, configured to determine a skin color estimation region of interest and an illumination estimation region of interest in the face image based on the face key point; a skin color detection module, configured to obtain a detected skin color value corresponding to the skin color estimation region of interest; an illumination detection module, configured to obtain a detected illumination color value corresponding to the illumination estimation region of interest; and a skin color correction module, configured to use the detected skin color value and the detected illumination color value as feature input of a skin color estimation model, and obtain a corrected skin color value output by the skin color estimation model.

The skin color detection apparatus may use the skin color detection method in the foregoing embodiment. A specific process and principle are the same as the process and the principle in the foregoing embodiment, and details are not described herein. It should be understood that division of the modules of the skin color detection apparatus is merely division of logical functions, and during actual implementation, the modules may be all or partially integrated into one physical entity, or may be physically separated. In addition, all of these modules may be implemented in a form of software to be invoked by a processing element, or may be implemented in a form of hardware. Alternatively, some modules may be implemented in a form of software to be invoked by a processing element, and some modules may be implemented in a form of hardware. For example, the skin color correction module may be a separately disposed processing element, or may be integrated into, for example, a chip of a terminal for implementation. In addition, the skin color correction module may alternatively be stored in a memory of the terminal in a form of a program, and a processing element of the terminal invokes and executes functions of the foregoing modules. Implementation of another module is similar. In addition, all or some of these modules may be integrated together, or may be independently implemented. The processing element may be an integrated circuit chip and has a signal processing capability. In an implementation process, steps in the foregoing methods or the foregoing modules can be implemented by using a hardware integrated logical circuit in the processing element, or by using instructions in a form of software.

For example, the foregoing modules may be one or more integrated circuits configured to perform the foregoing method, such as one or more application-specific integrated circuits (ASIC), one or more microprocessors (digital signal processor, DSP), or one or more field programmable gate arrays (FPGA). For another example, when one of the foregoing modules is implemented by a processing element by scheduling a program, the processing element may be a general purpose processor, for example, a central processing unit (CPU) or another processor that may invoke a program. For another example, the modules may be integrated together and implemented in a form of a system-on-a-chip (SOC).

An embodiment of this application further provides a skin color detection apparatus, including a processor and a memory. The memory is configured to store at least one instruction, and when the instruction is loaded and executed by the processor, the skin color detection method in the foregoing embodiment is implemented.

A specific process and principle of the skin color detection method are the same as the process and the principle in the foregoing embodiment, and details are not described herein. There may be one or more processors, and the processor and the memory may be connected by using a bus or in another manner. As a non-transient computer-readable storage medium, the memory may be configured to store a non-transient software program and a non-transient computer-executable program and module. The processor runs the non-transient software program, instruction, and module stored in the memory, to execute various functional applications and data processing, that is, implement the method in any of the foregoing method embodiments. The memory may include a program storage area and a data storage area. The program storage area may store an operating system, an application required by at least one function, necessary data, and the like. In addition, the memory may include a high-speed random access memory, and may further include a non-transient memory, for example, at least one magnetic disk storage device, a flash device, or another non-transient solid-state storage device.

An embodiment of this application further provides a terminal, including the foregoing skin color detection apparatus. The terminal may be specifically an intelligent terminal device such as a mobile phone or a tablet computer, and the terminal further includes a display apparatus. The terminal may implement communication with a server. A skin color estimation model may be established in advance through training based on data stored in the server. When performing skin color detection, the terminal may invoke the model trained on the server, to obtain a result output by the skin color estimation model, and display the result.

An embodiment of this application further provides a computer-readable storage medium. The computer-readable storage medium stores a computer program, and when the computer program is run on a computer, the computer is enabled to perform the foregoing skin color detection method.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, all or some of the procedures or functions in this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (Solid State Disk)), or the like.

In this application, at least one means one or more, and a plurality of means two or more. The term “and/or” describes an association relationship for describing associated objects and represents that three relationships may exist. For example, A and/or B may represent the following three cases: Only A exists, both A and B exist, and only B exists, where A and B may be singular or plural. The character “I” usually indicates an “or” relationship between associated objects. At least one of the following items (pieces) or a similar expression thereof indicates any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

The foregoing is merely a preferred embodiment of this application, but is not intended to limit this application. For a person skilled in the art, various modifications and variations may be made to this application. Any modification, equivalent replacement, or improvement made without departing from the spirit and principle of this application shall fall within the protection scope of this application.

1. A skin color detection method, comprising:
obtaining a face image;
determining a face key point in the face image;
determining a skin color estimation region of interest and an illumination estimation region of interest in the face image based on the face key point;
obtaining a detected skin color value corresponding to the skin color estimation region of interest;
obtaining a detected illumination color value corresponding to the illumination estimation region of interest; and
using the detected skin color value and the detected illumination color value as feature input of a skin color estimation model; and
obtaining a corrected skin color value output by the skin color estimation model.

2. The skin color detection method according to claim 1, wherein
the obtaining a detected skin color value corresponding to the skin color estimation region of interest comprises:
obtaining, through screening by using an elliptic skin color model, a pixel that is in the skin color estimation region of interest and that meets a preset condition; and
calculating an average value of detected skin color values of the skin color estimation region of interest based on the pixel that is in the skin color estimation region of interest and that meets the preset condition, and using the average value as the detected skin color value corresponding to the skin color estimation region of interest.

3. The skin color detection method according to claim 1, wherein
the obtaining a detected illumination color value corresponding to the illumination estimation region of interest comprises:
obtaining the detected illumination color value corresponding to the illumination estimation region of interest using Gaussian filtering and a shades of gray algorithm.

4. The skin color detection method according to claim 1, wherein
the corrected skin color value output by the skin color estimation model comprises one of an red-green-blue (RGB) color value or an LAB color value.

5. The skin color detection method according to claim 1, wherein
the obtaining a corrected skin color value output by the skin color estimation model comprises: obtaining an red-green-blue (RGB) color value output by the skin color estimation model; and
the skin color detection method further comprises:
converting the RGB color value output by the skin color estimation model into an hue saturation value (HSV) color value, and determining a skin color tone based on the HSV color value; and
converting the RGB color value output by the skin color estimation model into an LAB color value, obtaining a corresponding individual typology angle (ITA) based on the LAB color value, and determining a skin color code based on the ITA.

6. The skin color detection method according to claim 1, wherein
the obtaining a corrected skin color value output by the skin color estimation model comprises: obtaining an red-green-blue (RGB) color value and an individual typology angle (ITA) that are output by the skin color estimation model; and
the skin color detection method further comprises:
converting the RGB color value output by the skin color estimation model into an HSV color value, and determining a skin color tone based on the hue saturation value (HSV) color value; and
determining a skin color code based on the ITA output by the skin color estimation model.

7. The skin color detection method according to claim 5, wherein the skin color detection method further comprises:
generating a skin detection result interface, wherein the skin detection result interface comprises a skin color bar, and the skin color bar comprises the skin color code; and
generating a skin color details interface in response to a selection instruction of the skin color bar, wherein the skin color details interface comprises the skin color code, the skin color tone, and a skin care suggestion.

8. The skin color detection method according to claim 1, wherein
before the obtaining a face image, the skin color detection method further comprises:
generating a skin detection interface, wherein the skin detection interface comprises skin detection history information and a skin detection icon; and
in response to a selection instruction of the skin detection icon, entering a process of obtaining the face image.

9-12. (canceled)

13. The skin color detection method according to claim 1, wherein
wherein the determining a skin color estimation region of interest comprising:
obtaining a first rectangle based on a second plurality of face key points, wherein the second plurality of face key points are selected from the first plurality of face key points;
obtaining a central point of the first rectangle;
zooming out the first rectangle based on the central point to generate the skin color estimation region of interest, wherein the skin color estimation region of interest is a rectangle smaller than the first rectangle.

14. The skin color detection method according to claim 1, wherein the determining an illumination estimation region of interest comprising:
obtaining a second rectangle as the illumination estimation region of interest based on a third plurality of face key points, wherein the third plurality of face key points are selected from the first plurality of face key points.

15. A skin color detection apparatus, comprising:
a processor and a non-transitory memory, wherein the memory is configured to store at least one instruction, and when the instruction is loaded and executed by the processor, the apparatus is enabled to perform:
obtaining a face image;
determining a first plurality of face key points in the face image;
determining a skin color estimation region of interest and an illumination estimation region of interest in the face image based on the face key points;
obtaining a detected skin color value corresponding to the skin color estimation region of interest;
obtaining a detected illumination color value corresponding to the illumination estimation region of interest;
using the detected skin color value and the detected illumination color value as feature input of a skin color estimation model; and
obtaining a corrected skin color value output by the skin color estimation model.

16. The skin color detection apparatus according to claim 15, wherein the apparatus is further enabled to perform:
obtaining, through screening by using an elliptic skin color model, a pixel that is in the skin color estimation region of interest and that meets a preset condition; and
calculating an average value of detected skin color values of the skin color estimation region of interest based on the pixel that is in the skin color estimation region of interest and that meets the preset condition, and using the average value as the detected skin color value corresponding to the skin color estimation region of interest.

17. The skin color detection apparatus according to claim 15, wherein the apparatus is further enabled to perform:
obtaining the detected illumination color value corresponding to the illumination estimation region of interest using Gaussian filtering and a shades of gray algorithm.

18. The skin color detection apparatus according to claim 15, wherein
the corrected skin color value output by the skin color estimation model comprises one of an red-green-blue (RGB) color value or an LAB color value.

19. The skin color detection apparatus according to claim 15, wherein the apparatus is further enabled to perform:
obtaining an red-green-blue (RGB) color value output by the skin color estimation model;
converting the RGB color value output by the skin color estimation model into an hue saturation value (HSV) color value, and determining a skin color tone based on the HSV color value; and
converting the RGB color value output by the skin color estimation model into an LAB color value, obtaining a corresponding individual typology angle (ITA) based on the LAB color value, and determining a skin color code based on the ITA.

20. The skin color detection apparatus according to claim 15, wherein the apparatus is further enabled to perform:
obtaining an red-green-blue (RGB) color value and an individual typology angle (ITA) that are output by the skin color estimation model;
converting the RGB color value output by the skin color estimation model into an hue saturation value (HSV) color value, and determining a skin color tone based on the HSV color value; and
determining a skin color code based on the ITA output by the skin color estimation model.

21. The skin color detection apparatus according to claim 19, wherein the apparatus is further enabled to perform:
generating a skin detection result interface, wherein the skin detection result interface comprises a skin color bar, and the skin color bar comprises the skin color code; and
generating a skin color details interface in response to a selection instruction of the skin color bar, wherein the skin color details interface comprises the skin color code, the skin color tone, and a skin care suggestion.

22. The skin color detection apparatus according to claim 15, wherein the apparatus is further enabled to perform:
before the obtaining a face image, generating a skin detection interface, wherein the skin detection interface comprises skin detection history information and a skin detection icon; and
in response to a selection instruction of the skin detection icon, entering a process of obtaining the face image.

23. The skin color detection apparatus according to claim 15, wherein the apparatus is further enabled to perform:
obtaining a first rectangle based on a second plurality of face key points, wherein the second plurality of face key points are selected from the first plurality of face key points;
obtaining a central point of the first rectangle;
zooming out the first rectangle based on the central point to generate the skin color estimation region of interest; wherein the skin color estimation region of interest is a rectangle smaller than the first rectangle.

24. The skin color detection apparatus according to claim 15, wherein the apparatus is further enabled to perform:
obtaining a second rectangle as the illumination estimation region of interest based on a third plurality of face key points, wherein the third plurality of face key points are selected from the first plurality of face key points.
